(19) United States
(12) Patent Application Publication
(10) Pub. No.: US 2025/0036931 A1
(43) Pub. Date: Jan. 30, 2025

(54) NODE AND RESERVOIR DEVICE

(71) Applicant: TDK Corporation, Tokyo (JP)

(72) Inventors: Yukio TERASAKI, Tokyo (JP); Kazuki Nakada, Tokyo (JP); Eiji Suzuki, Tokyo (JP); Keita Suda, Tokyo (JP); Tomoyuki Sasaki, Tokyo (JP); Tetsuya Asai, Sapporo-shi (JP); Yuki Abe, Sapporo-shi (JP)

(73) Assignee: TDK Corporation, Tokyo (JP)

(21) Appl. No.: 18/784,000

(22) Filed: Jul. 25, 2024

(30) Foreign Application Priority Data
Jul. 27, 2023 (JP) 2023-122359

(51) Int. Cl. G06N 3/065; G06N 3/0442

(52) U.S. Cl. CPC G06N 3/065; G06N 3/0442

(57) ABSTRACT

The node includes a first input terminal, a second input terminal, a first sample and hold circuit, and a first output terminal. The first input terminal is configured to be connectable to an input source for transmitting an input signal to a reservoir device. The second input terminal is configured to be connectable to at least one other node. A first terminal of the first sample and hold circuit is connected to the first input terminal and the second input terminal. A second terminal of the first sample and hold circuit is connected to the first output terminal. The first output terminal is configured to be connectable to at least one other node. The first sample and hold circuit holds and converts a joined signal of the input signal and a propagated signal from the second input terminal.

### BACKGROUND OF THE INVENTION

### Field of the Invention

The present invention relates to a node and a reservoir device.

### Description of Related Art

A neuromorphic device is a device that imitates the human brain using a neural network. A neuromorphic device artificially imitates a relationship between neurons and synapses in the human brain.

For example, a neuromorphic device includes nodes that are hierarchically arranged (neurons in the brain) and transmission means that connect the nodes (synapses in the brain). A neuromorphic device enhances a rate of correct answers to questions by training the transmission means (synapses). Learning is finding knowledge which is likely to be used in the future from information, and weights are applied to the input data in neuromorphic device.

A recurrent neural network is known as a neural network. The recurrent neural network can handle nonlinear time-series data. Nonlinear time-series data is data of which a value changes with the elapse of time, and an example thereof is stock prices. The recurrent neural network can process time-series data by feeding processed results in neurons in a subsequent layer back to neurons in a preceding layer.

Reservoir computing is a means for realizing a recurrent neural network. Reservoir computing performs a recursive process by causing signals to interact based on internal connections. Recently, for example, as described in Non Patent Document 1, the concept of reservoir computing has been tried to be realized by an actual device. A device to which the concept of reservoir computing is applied is referred to as a physical reservoir device or a reservoir device.

### PATENT DOCUMENTS

[Non Patent Literature 1] K. Toprasertpong, E. Nako, Z. Wang, R. Nakane, M. Takenaka, and S. Takagi, “Reservoir computing on a silicon platform with a ferroelectric field-effect transistor,” Communications Engineering, 1, 21, August 2022 (DOI: 10.1038/s44172-022-00021-8)

### SUMMARY OF THE INVENTION

Short term memory property is one of performance metrics required for a reservoir device. The short term memory property is a criterion for determining how past information can be stored or forgotten. In general, a reservoir device having short term memory property optimal for a given task outputs an estimated solution by considering data in a required section prior to the current time out of time-series data and ignoring past data older than necessary. However, when a reservoir device is intended to realize using an electronic circuit, a physical device, or the like, there is a problem in that short term memory property thereof cannot be achieved enough. As a result, since a reservoir device with poor short term memory property outputs an estimated solution using only most recent data in time-series data, sufficient performance is not obtained.

The present disclosure was made in consideration of the aforementioned circumstances and provides a node and a reservoir device with excellent short term memory property.

(1) A node according to a first aspect includes a first input terminal, a second input terminal, a first sample and hold circuit, and a first output terminal. The first input terminal is configured to be connectable to an input source for transmitting an input signal to a reservoir device. The second input terminal is configured to be connectable to at least one other node. A first terminal of the first sample and hold circuit is connected to the first input terminal and the second input terminal. A second terminal of the first sample and hold circuit is connected to the first output terminal. The first output terminal is configured to be connectable to at least one other node. The first sample and hold circuit holds and converts a joined signal of the input signal and a propagated signal from the second input terminal.

(2) In the node according to the aspect, the first sample and hold circuit may include a first switch, a second switch, a first capacitor, a second capacitor, and an amplification circuit. The first switch is disposed between the first terminal and the first capacitor. The first capacitor is disposed between the first switch and the second switch. The second switch is disposed between the first capacitor and the second capacitor. The second capacitor is disposed between the second switch and the second terminal. The amplification circuit is connected to the first capacitor and amplifies a potential of the first capacitor.

(3) In the node according to the aspect, the first capacitor may be a variable capacitor of which a capacitance is variable.

(4) In the node according to the aspect, the second switch may be turned off when the first switch is turned on, and the first switch may be turned off when the second switch is turned on.

(5) In the node according to the aspect, a first clock signal for controlling turning-on/off of the first switch or a second clock signal for controlling turning-on/off of the second switch may be variable.

(6) The node according to the aspect may further include a second output terminal connected to the second terminal. The second output terminal is configured to be connectable to a read-out for outputting a signal to outside of the reservoir device.

(7) The node according to the aspect may further include a third switch that is disposed between the second output terminal and the second terminal.

(8) The node according to the aspect may further include a nonlinear circuit. The nonlinear circuit is connected to the second terminal and the first output terminal.

(9) In the node according to the aspect, the nonlinear circuit converts an input first signal to a second signal nonlinearly. The second signal and the first signal may satisfy a relational expression of y≠ax+b. In the relational expression, y is the second signal, x is the first signal, and a and b are arbitrary values.

(10) In the node according to the aspect, the second input terminal may be configured to be connectable to a plurality of nodes.

(11) In the node according to the aspect, the first output terminal may be configured to be connectable to a plurality of nodes.

(12) A reservoir device according to a second aspect includes a plurality of nodes. At least one of the plurality of nodes is the node according to the aspect.

(13) In the reservoir device according to the aspect, at least some of the plurality of nodes may be connected in a ring shape.

(14) In the reservoir device according to the aspect, the at least one of the plurality of nodes may include a third input terminal, a second sample and hold circuit, and a third output terminal. The third input terminal is configured to be connectable to at least one other node. A first terminal of the second sample and hold circuit is connected to the third input terminal. A second terminal of the second sample and hold circuit is connected to the third output terminal. The third output terminal is configured to be connectable to at least one other node. The second sample and hold circuit holds and converts a propagated signal from the third input terminal.

The node and the reservoir device according to the aspects have excellent short term memory property.

### BRIEF DESCRIPTION OF THE DRAWINGS

FIG. 1 is a conceptual diagram of a neural network that is imitated by a reservoir device according to a first embodiment.

FIG. 2 is a diagram illustrating a configuration of an information processing device according to the first embodiment.

FIG. 3 is a diagram illustrating a configuration of another example of the information processing device according to the first embodiment.

FIG. 4 is a diagram illustrating a configuration of a reservoir device according to the first embodiment.

FIG. 5 is a circuit diagram of a node according to the first embodiment.

FIG. 6 is a diagram illustrating an operation of a sample and hold circuit according to the first embodiment.

FIG. 7 is a diagram illustrating nonlinear characteristics of a node according to the first embodiment.

FIG. 8 is a plan view of a capacitor according to a first modified example.

FIG. 9 is a sectional view of the capacitor according to the first modified example.

FIG. 10 is a circuit diagram of a sample and hold circuit according to a second modified example.

FIG. 11 is a circuit diagram of a sample and hold circuit according to a third modified example.

FIG. 12 is a circuit diagram of a sample and hold circuit according to a fourth modified example.

FIG. 13 is a diagram illustrating a configuration of a reservoir device according to a second embodiment.

FIG. 14 is a circuit diagram of a node according to the second embodiment.

FIG. 15 is a diagram illustrating a configuration of a reservoir device according to a third embodiment.

FIG. 16 is a circuit diagram of a node according to the third embodiment.

FIG. 17 is a diagram illustrating a configuration of a reservoir device according to a fourth embodiment.

FIG. 18 is a circuit diagram of a node according to the fourth embodiment.

FIG. 19 is a diagram illustrating a configuration of a reservoir device according to a fifth embodiment.

FIG. 20 is a diagram illustrating a configuration of a reservoir device according to a sixth embodiment.

FIG. 21 is a diagram illustrating a configuration of a reservoir device according to a seventh embodiment.

### DETAILED DESCRIPTION OF THE INVENTION

Hereinafter, embodiments will be described in detail with reference to the accompanying drawings. In the drawings referred to in the following description, featured constituents may be conveniently enlarged for the purpose of easy understanding of features of the present disclosure, and dimensions, proportions, and the like of the constituents may be different from actual ones. Materials, dimensions, and the like exemplified in the following description are only examples, and the present disclosure is not limited thereto and can be appropriately modified within a range in which advantages of the present disclosure are achieved.

### First Embodiment

A reservoir device according to the embodiments is the device executing processes in reservoir computing by device. Reservoir computing is an example of a recurrent neural network.

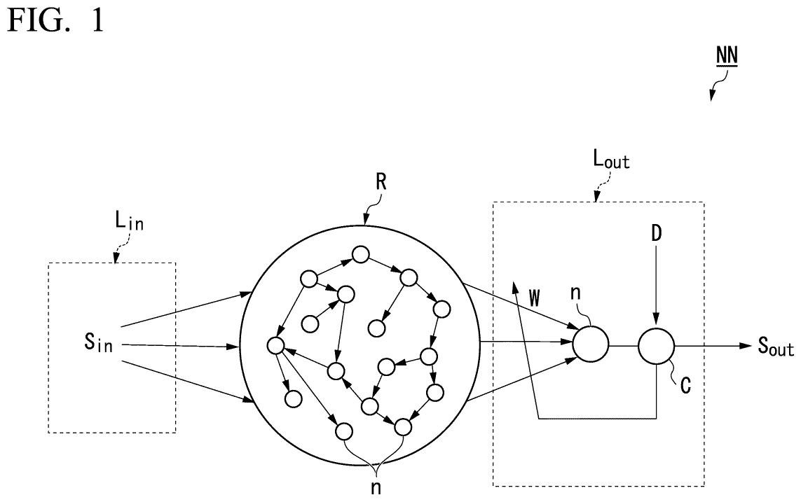

FIG. 1 is a conceptual diagram of a neural network that is imitated by a reservoir device according to a first embodiment. A neural network NN illustrated in FIG. 1 shows the concept of reservoir computing. The neural network NN illustrated in FIG. 1 includes an input layer Lᵢₙ, a reservoir layer R, and an output layer Lₒᵤₜ. The input layer Lᵢₙ and the output layer Lₒᵤₜ are connected to the reservoir layer R.

The input layer Lᵢₙ inputs an input signal Sᵢₙ to the reservoir layer R. The input signal Sᵢₙ is, for example, a signal detected by a sensor. The input signal Sᵢₙ may be an analog signal or may be a digital signal. The input signal Sᵢₙ may include a plurality of signals. Resistors or the like which work as different weights to each input signals may be disposed in series for each input signals.

The reservoir layer R stores input signals from the input layer Lᵢₙ and converts the input signals to different signals. In the reservoir layer R, connection weights between nodes n have fixed values set by using a random number or the like, and the connection weights between nodes n are not generally trained. The input signal changes nonlinearly in the reservoir layer R. The input signals change with the elapse of time by interacting with each other in the reservoir layer R. The reservoir layer R includes a plurality of nodes n. The nodes n correspond to neurons in a neural circuit, and connections between the nodes n correspond to synapses. The plurality of nodes n are randomly connected. For example, a signal output from a certain node n at time t may return to the node n having output the signal at time t+1. The node n performs a process in consideration of the signals at time t and time t+1, and information is recursively processed.

The output layer Lₒᵤₜ receives an input of a signal from the reservoir layer R and outputs an output signal Sₒᵤₜ based on the signal. The output layer Lₒᵤₜ performs a learning process and an inference process. In the learning process, the output layer Lₒᵤₜ compares the output from the reservoir layer R with training data D using a comparator C and adjusts weights w which are applied between the nodes n of the reservoir layer R and the nodes n of the output layer Lₒᵤₜ. The weights w are determined in the learning process. In the inference process, the output layer Lₒᵤₜ outputs an inference result based on input signals Sᵢₙ and the weights w as the output signal Sₒᵤₜ.

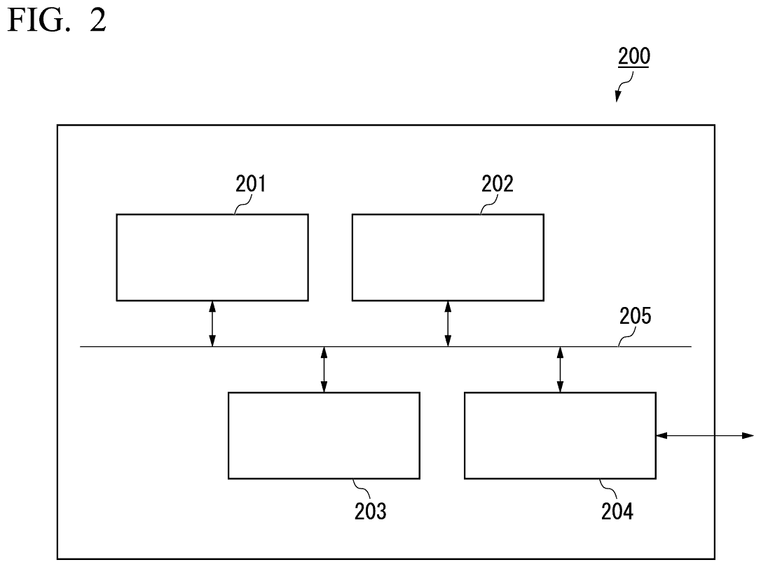

FIG. 2 is a diagram illustrating a configuration of an information processing device 200 according to the first embodiment. The information processing device 200 is hardware for operating a neural network NN.

The information processing device 200 includes, for example, a physical reservoir 201, a processor 202, a memory 203, and a communication device 204. The physical reservoir 201, the processor 202, the memory 203, and the communication device 204 are connected via a bus 205.

The physical reservoir 201 is a physical device that performs processes of the neural network NN. The processor 202 executes a program stored in the memory 203. The memory 203 includes a program storage area for storing a program and information storage area for storing information from the physical reservoir 201. The memory 203 is, for example, a dynamic random access memory (DRAM), a static random access memory (SRAM), a hard disk drive (HDD), or a solid state drive (SSD). The physical reservoir 201 performs the learning process or the inference process based on an instruction from the processor 202. The communication device 204 outputs a signal to outside of the information processing device 200. The communication device 204 may be of a wired type or a wireless type.

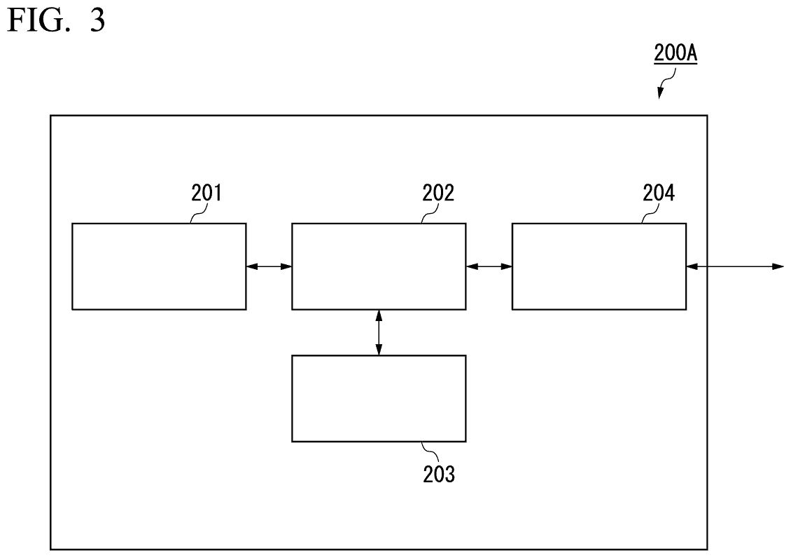

The information processing device 200 is an example of an information processing device according to the first embodiment, and the information processing device is not limited to this example. For example, FIG. 3 is a diagram illustrating a configuration of another example of the information processing device according to the first embodiment. Like the information processing device 200A illustrated in FIG. 3, the physical reservoir 201, the processor 202, the memory 203, and the communication device 204 may be connected to each other without using the bus 205.

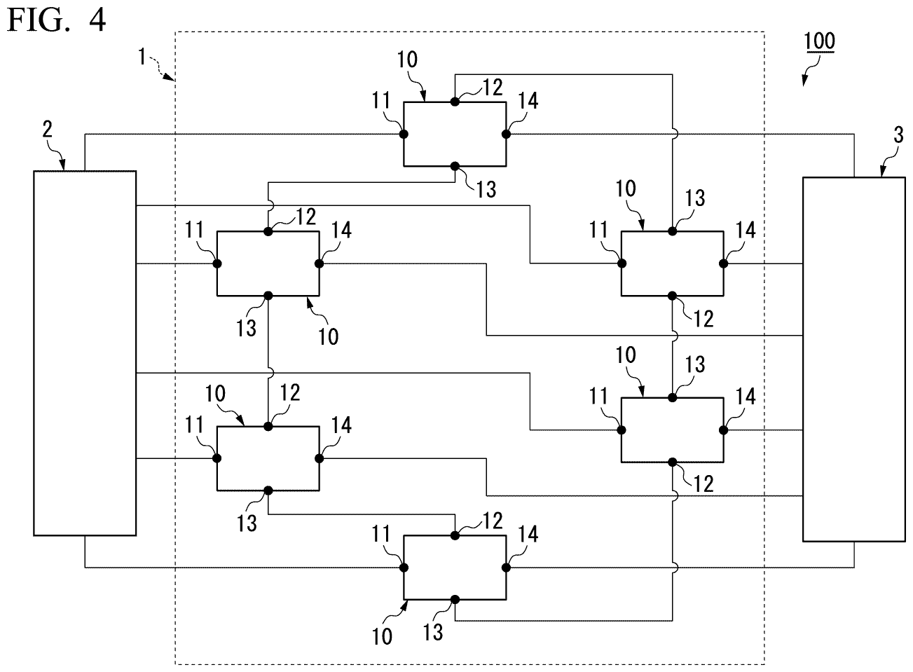

FIG. 4 is a diagram illustrating a configuration of a reservoir device 100 according to the first embodiment. The reservoir device 100 is an example of the physical reservoir 201, and circuits thereof perform processes of the neural network NN.

The reservoir device 100 includes a reservoir 1, an input unit 2, and a read-out 3. The input unit 2 corresponds to the input layer Lᵢₙ illustrated in FIG. 1. The reservoir 1 corresponds to the reservoir layer R illustrated in FIG. 1. The read-out 3 corresponds to the output layer Lₒᵤₜ illustrated in FIG. 1. The input unit 2 includes, for example, a plurality of sensors and analog-digital converters. The read-out 3 includes, for example, a product-sum operation circuit, a comparison circuit, and an output circuit.

The reservoir 1 includes a plurality of nodes 10. At least one of the nodes included in the reservoir 1 is a node 10 which will be described later. The number of nodes 10 included in the reservoir 1 is not particularly limited. Each node 10 includes, for example, a first input terminal 11, a second input terminal 12, a first output terminal 13, and a second output terminal 14. Different nodes 10 are connected by a line connecting the second input terminal 12 and the first output terminal 13. In the example illustrated in FIG. 4, a plurality of nodes 10 are connected in a ring shape by lines connecting the second input terminal 12 and the first output terminal 13. The connection between nodes 10 illustrated in FIG. 4 is an example, and connection between nodes 10 and arrangement of the nodes 10 are not limited thereto.

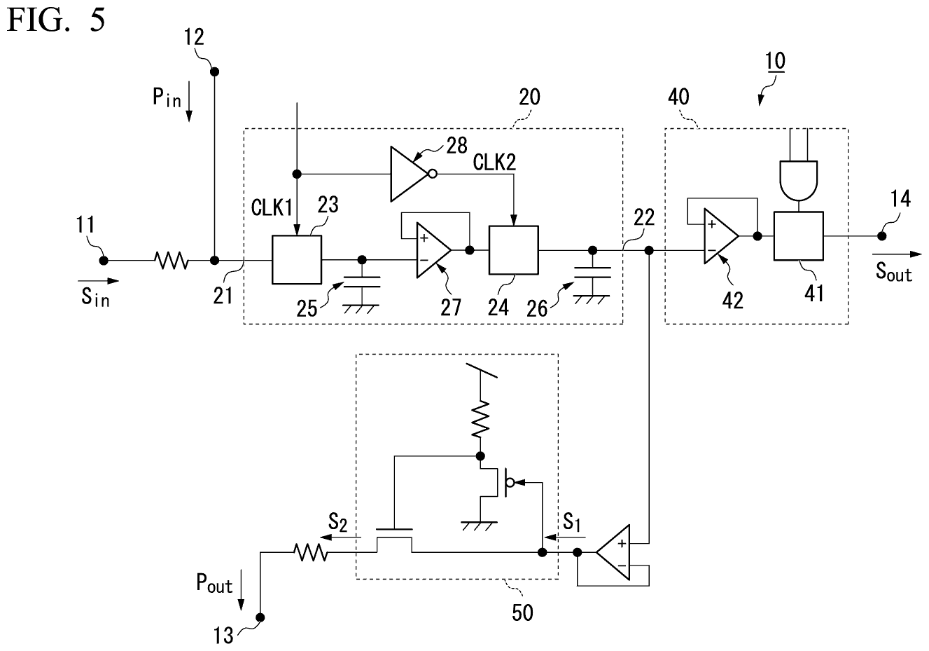

FIG. 5 is a circuit diagram of a node 10 according to the first embodiment. The node 10 includes, for example, the first input terminal 11, the second input terminal 12, the first output terminal 13, the second output terminal 14, a sample and hold circuit 20, an output circuit 40, and a nonlinear circuit 50. The node 10 may include a resistor and an amplifier in addition. The sample and hold circuit 20 is an example of a first sample and hold circuit in the claims.

The first input terminal 11 is connected to, for example, the input unit 2. The input unit 2 is connected to an input source for transmitting an input signal Sᵢₙ to the reservoir device 100. The input source is, for example, a sensor. The first input terminal 11 is configured to be connectable to the input source for transmitting the input signal Sᵢₙ to the reservoir device 100 via the input unit 2. The input signal Sᵢₙ is input to the first input terminal 11.

The second input terminal 12 is configured to be connectable to at least one other node 10. The second input terminal 12 is connected to, for example, the first output terminal 13 of another node 10. A propagation signal Pᵢₙ from the other node 10 is input to the second input terminal 12.

The sample and hold circuit 20 includes, a first terminal 21, a second terminal 22, a first switch 23, a second switch 24, a first capacitor 25, a second capacitor 26, an amplifier 27, and an inverter 28.

The first terminal 21 is a signal input terminal of the sample and hold circuit 20. The first terminal 21 is connected to the first input terminal 11 and the second input terminal 12. A joined signal of the input signal Sᵢₙ and the propagated signal Pᵢₙ is input to the first terminal 21.

The second terminal 22 is a signal output terminal of the sample and hold circuit 20. The second terminal 22 is connected to the first output terminal 13. As illustrated in FIG. 5, an element (for example, a resistor) or a circuit (for example, a nonlinear circuit 50) may be provided between the second terminal 22 and the first output terminal 13. The second terminal 22 outputs a signal which is a result of conversion by the sample and hold circuit 20.

The first switch 23 is provided between the first terminal 21 and the first capacitor 25. The second switch 24 is provided between the second terminal 22 and the first capacitor 25. The second switch 24 is provided, for example, between the first capacitor 25 and the second capacitor 26. A known switch can be used as the first switch 23 and the second switch 24, and for example, a MOSFET switch can be used. The first switch 23 operates with a first clock signal CLK1, and the second switch 24 operates with a second clock signal CLK2. The first clock signal CLK1 and the second clock signal CLK2 are input from the processor 202.

In the example illustrated in FIG. 5, the second clock signal CLK2 is the inverted first clock signal CLK1 by the inverter 28. Accordingly, the second switch 24 is turned off when the first switch 23 is turned on, and the first switch 23 is turned off when the second switch 24 is turned on.

The first capacitor 25 is provided between the first switch 23 and the second switch 24. One electrode of the first capacitor 25 is connected to a line connecting the first switch 23 and the amplifier 27, and the other electrode of the first capacitor 25 is grounded. The first capacitor 25 accumulates electric charge when the first switch 23 is turned on and the second switch 24 is turned off, and discharges electric charge when the first switch 23 is turned off and the second switch 24 is turned on. The amplifier 27 is connected to the first capacitor 25. The amplifier 27 amplifies the potential of the first capacitor 25.

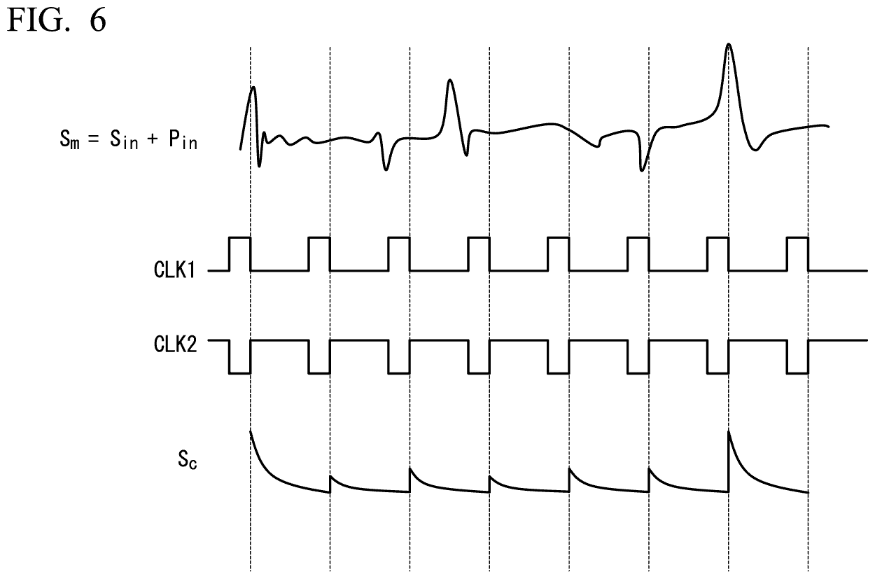

The sample and hold circuit 20 holds and converts the joined signal Sₘ of the input signal Sᵢₙ and the propagated signal Pᵢₙ. FIG. 6 is a diagram illustrating the operation of the sample and hold circuit 20 according to the first embodiment. When the first switch 23 is turned on and the second switch 24 is turned off, the joined signal Sₘ reaches the first capacitor 25. The first capacitor 25 accumulates electric charge based on the joined signal Sₘ. That is, the joined signal is held by the first capacitor 25 in a predetermined time. Subsequently, when the first switch 23 is turned off and the second switch 24 is turned on, the electric charge accumulated in the first capacitor 25 is discharged. At this time, the joined signal Sₘ is nonlinearly converted to a converted signal Sc. The converted signal Se is amplified by the amplifier 27 and output from the second terminal 22. Since the joined signal Sₘ is held in the first capacitor 25 in a predetermined period, the sample and hold circuit 20 enhances short term memory property of the reservoir device 100. Since the joined signal Sₘ is nonlinearly converted to the converted signal Sc, the sample and hold circuit 20 contributes to nonlinear conversion of the reservoir device 100. In FIG. 6, the first clock signal CLK1 and the second clock signal CLK2 have different duty ratios, but the duty ratios of the first clock signal CLK1 and the second clock signal CLK2 may be 50:50.

The second capacitor 26 is disposed before the second terminal 22. The second capacitor 26 is connected to, for example, the second switch 24 and the second terminal 22. One electrode of the second capacitor 26 is connected to a line extending to the second terminal 22, and the other electrode of the second capacitor 26 is grounded. The nonlinear circuit 50 may be provided between the second terminal 22 and the first output terminal 13. Since the second capacitor 26 accumulates a part of a signal output from the second terminal 22, it is possible to contribute to enhancement of the short term memory property. The second capacitor 26 is not essential, but may be skipped.

The output circuit 40 is connected to the second terminal 22 and the second output terminal 14. The second output terminal 14 is configured to be connectable to, for example, the read-out 3. In the reservoir device 100, the second output terminal 14 is connected to the read-out 3. The read-out 3 outputs a signal to outside of the reservoir device 100. An output signal Sₒᵤₜ is output from the second output terminal 14.

The output circuit 40 includes, for example, a third switch 41 and an amplifier 42. The amplifier 42 amplifies the signal input to the output circuit 40. The third switch 41 switches connection between the second terminal 22 and the second output terminal 14. When the third switch 41 is turned on, the output signal Sₒᵤₜ is output from the second output terminal 14 to the read-out 3. When the third switch 41 is turned off, the output signal Sₒᵤₜ is not output from the second output terminal 14 to the read-out 3. In this case, the node 10 functions as an interaction between the node 10 connected to the second input terminal 12 and the node 10 connected to the first output terminal 13.

The nonlinear circuit 50 is connected to the second terminal 22 and the first output terminal 13. The nonlinear circuit 50 is, for example, a horizontal resistance circuit. The nonlinear circuit 50 converts a first signal S₁ to a second signal S₂ nonlinearly and outputs the second signal. The second signal S₂ and the first signal S₁ satisfy, for example, a relational expression y≠ax+b. In this relational expression, y is the second signal S₂, x is the first signal S₁, and a and b are arbitrary values. The first signal S₁ is a signal which is input from the sample and hold circuit 20.

The nonlinear circuit 50 enhances nonlinear characteristics of the reservoir device 100. The reservoir 1 projects an input signal Sᵢₙ to a nonlinear space, and an expressive ability of the reservoir device 100 increases as the nonlinearity of signal conversion in the reservoir 1 increases. Even when the node 10 does not include the nonlinear circuit 50, nonlinear conversion occurs by the sample and hold circuit 20, and thus the nonlinear circuit 50 is not essential for the node 10. However, when the node 10 includes the nonlinear circuit 50, the reservoir device 100 can process more complex signals.

The first output terminal 13 is configured to be connectable to at least one other node 10. The first output terminal 13 is connected to, for example, the second input terminal 12 of the other node 10. A propagation signal Pₒᵤₜ is output from the first output terminal 13 to the other node 10. The input signal Sᵢₙ from the first input terminal 11 and the propagated signal Pᵢₙ from the second input terminal 12 are converted to the propagation signal Pₒᵤₜ through propagating in the node 10.

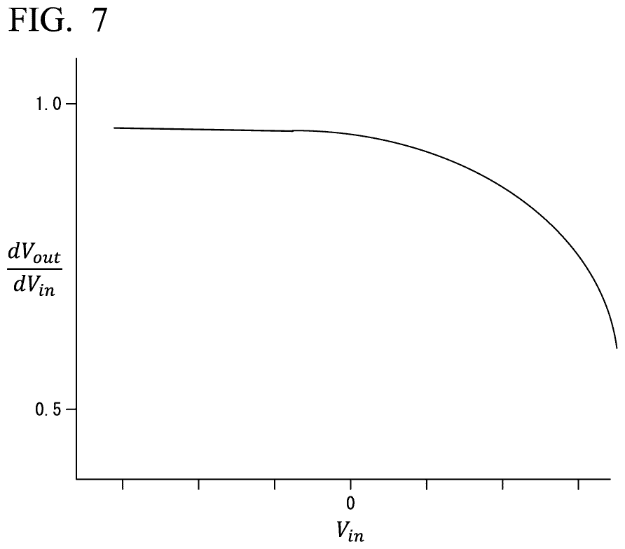

The reservoir device 100 according to the first embodiment, a plurality of nodes 10 are connected, and signals interact with each other while being nonlinearly converted between the nodes 10. FIG. 7 is a graph illustrating a measurement result of nonlinear conversion characteristics of the reservoir device 100 according to the first embodiment. The horizontal axis of FIG. 7 represents a voltage Vᵢₙ corresponding to the propagation signal Pᵢₙ input to the second input terminal 12. The vertical axis of FIG. 7 represents a value obtained by dividing a change width per unit time of a voltage Vₒᵤₜ corresponding to the propagation signal Pₒᵤₜ output from the first output terminal 13 by a change width per unit time of the voltage Vᵢₙ corresponding to the propagation signal Pᵢₙ and is a differential value of the voltage Vₒᵤₜ corresponding to the propagation signal Pₒᵤₜ. As illustrated in FIG. 7, it was confirmed that the propagation signal Pₒᵤₜ converts the propagation signal Pᵢₙ nonlinearly. The reservoir device 100 has implemented a structure of neural network NN by a physical circuit (hardware) therein, not by software.

In the reservoir device 100 according to the first embodiment, an input signal Sᵢₙ from the input unit 2 is input to each of a plurality of nodes 10, and the input signal Sᵢₙ is held in the sample and hold circuit 20 in a predetermined period. Holding the input signal Sᵢₙ for a predetermined period means that past information is held in the reservoir device 100. That is, the reservoir device 100 according to the first embodiment has excellent short term memory property. The short term memory property of the reservoir device 100 using the node 10 illustrated in FIG. 5 was 60. On the other hand, the short term memory property of a reservoir device using a node 10 with excluding the sample and hold circuit 20 illustrated in FIG. 5 was 15. Since the node 10 includes the sample and hold circuit 20, it can be confirmed that the short term memory property of the reservoir device 100 can be enhanced.

An example of the reservoir device 100 according to the first embodiment has been described above in detail, and the reservoir device according to the first embodiment can be modified and improved in various forms within the range of the gist of the present disclosure.

For example, the first capacitor 25 illustrated in FIG. 5 is a capacitor with a constant capacitance, but the first capacitor 25 may be a variable capacitor of which a capacitance is variable. The second capacitor 26 may be a variable capacitor of which a capacitance is variable. In the following description, the first capacitor 25 will be described.

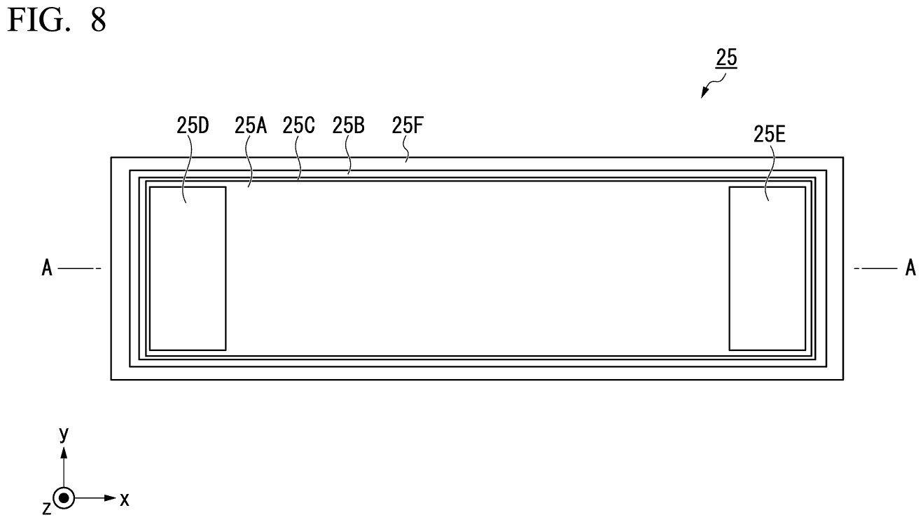

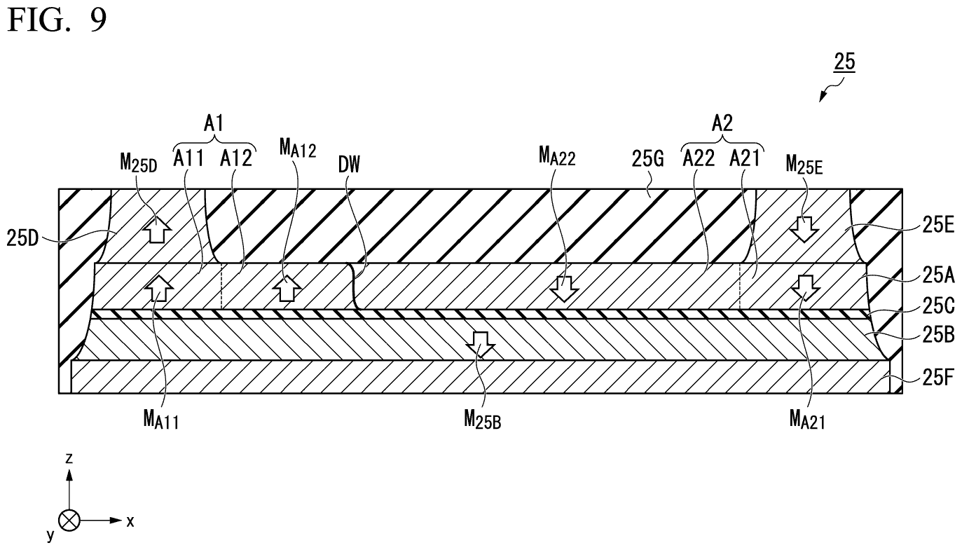

FIG. 8 is a plan view of a first capacitor according to a first modified example. FIG. 9 is a sectional view of the first capacitor according to the first modified example. The first capacitor 25 includes a first conductive layer 25A, a second conductive layer 25B, a capacitance layer 25C, a first electrode 25D, a second electrode 25E, and a third electrode 25F. A conductance of the first capacitor 25 changes with change in magnetization of the first conductive layer 25A and the second conductive layer 25B interposing the capacitance layer 25C therebetween. The first capacitor 25 is covered by, for example, an insulating layer 25G.

The first conductive layer 25A is a ferromagnetic layer including a ferromagnetic material. The first conductive layer 25A may be a ferromagnetic layer formed of a ferromagnetic material.

Examples of the ferromagnetic material include a metal selected from a group consisting of Cr, Mn, Co, Fe, and Ni, an alloy including one or more kinds of the metals, and an alloy including at least one element of B, C, and N along with the metals. The ferromagnetic material may include, for example, one selected from a group consisting of a CoPt alloy, a CoNi alloy, a TbFeCo alloy, a CoFe alloy, and an alloy formed by replacing a part of the alloy. The ferromagnetic material is, for example, Co—Fe, Co—Fe—B, or Ni—Fe.

The ferromagnetic material may be, for example, a Heusler alloy. The Heusler alloy is a half-metal and has high spin polarizability. The Heusler alloy is an intermetallic compound having a chemical composition of XYZ or X₂YZ, where X is a noble metal element or a transition metal element such as Co, Fe, Ni, or group Cu in the periodic table, Y is a transition metal such as Mn, V, Cr, or group Ti or the element of X, and Z is a typical element of group III to group V. Examples of the Heusler alloy include Co₂FeSi, Co₂FeGe, Co₂FeGa, Co₂MnSi, Co₂Mn₁₋ₐFeₐAl_{b}Si_{1-b}, and Co₂FeGe_{1-c}Ga_{c}.

The first conductive layer 25A includes a first magnetic domain A1 and a second magnetic domain A2. A magnetic domain wall DW is at a boundary between the first magnetic domain A1 and the second magnetic domain A2.

The magnetic domain wall DW is configured to be movable at least in an area overlapping the capacitance layer 25C of the first conductive layer 25A in a stacking direction in a first direction in the plane of the first conductive layer 25A. For example, the magnetic domain wall DW is configured to be movable in an x direction in the first conductive layer 25A. The x direction is one direction in the plane in which layers extend. A y direction is a direction perpendicular to the x direction in the plane in which layers extend. A z direction is a direction perpendicular to the x direction and the y direction.

The magnetic domain wall DW moves in the x direction by changing a potential difference between the first electrode 25D and the second electrode 25E. The magnetic domain wall DW moves by applying a writing current (for example, a current pulse) in the x direction of the first conductive layer 25A, applying an external magnetic field to the first conductive layer 25A, or the like. For example, when a writing pulse is applied between the first electrode 25D and the second electrode 25E, the magnetic domain wall DW moves.

The first magnetic domain A1 includes a first area A11 and a second area A12. Magnetization in the first magnetic domain A1 is oriented in the same direction. Magnetization M_{A11} in the first area A11 and magnetization M_{A12} in the second area A12 are oriented in the same direction.

The first area A11 is an area overlapping the first electrode 25D when seen in the z direction and an area in which magnetization M_{A11} is fixed. Fixation of magnetization means that magnetization is not inverted in a normal operation of the first capacitor 25 (an external force greater than supposed is not applied). The first area A11 is referred to as a first magnetization fixed area.

The second area A12 is an area other than the first area A11 in the first magnetic domain A1. A volume of the second area A12 changes with movement of the magnetic domain wall DW.

The second magnetic domain A2 includes a third area A21 and a fourth area A22. Magnetization in the second magnetic domain A2 is oriented in the same direction. Magnetization in the second magnetic domain A2 is oriented in a direction different from the magnetization in the first magnetic domain A1. Magnetization M_{A21} in the third area A21 and magnetization M_{A22} in the fourth area A22 are oriented in the same direction.

The third area A21 is an area overlapping the second electrode 25E when seen in the z direction and an area in which magnetization M_{A21} is fixed. The third area A21 is referred to as a second magnetization fixed area.

The fourth area A22 is an area other than the third area A21 in the second magnetic domain A2. A volume of the fourth area A22 changes with movement of the magnetic domain wall DW.

The second area A12 and the fourth area A22 are collectively referred to as a magnetic domain wall moving area. The magnetic domain wall moving area is interposed between the first magnetization fixed area and the second magnetization fixed area.

The second conductive layer 25B is in contact with the capacitance layer 25C. The first conductive layer 25A and the second conductive layer 25B interpose the capacitance layer 25C therebetween.

The second conductive layer 25B is a ferromagnetic layer including a ferromagnetic material. The second conductive layer 25B may be a ferromagnetic layer formed of a ferromagnetic material. The same material as the material of the first conductive layer 25A can be used for the second conductive layer 25B. The material of the second conductive layer 25B and the material of the first conductive layer 25A may be the same or different from each other. Magnetization M_{25B} of the second conductive layer 25B is less likely to be inverted than magnetization of the first conductive layer 25A.

The capacitance layer 25C is interposed between the first conductive layer 25A and the second conductive layer 25B. The capacitance layer 25C is a dielectric layer. The capacitance layer 25C has insulating characteristics, and electric charge is accumulated in the first conductive layer 25A and the second conductive layer 25B interposing the capacitance layer 25C therebetween.

The capacitance layer 25C includes, for example, one selected from a group consisting of magnesium oxide (MgO), aluminum oxide (Al₂O₃), titanium oxide (TiO₂), barium titanate (BaTiO₃), magnesium aluminate (MgAl₂O₄), silicon oxide (SiO₂), magnesium titanate (MgTiO₃), and hafnium oxide (HfO₂). Composition ratios of elements in these oxide are not limited to stoichiometric compositions. When the capacitance layer 25C includes these materials, a change width in capacitance of the first capacitor 25 becomes greater.

The capacitance layer 25C may include aluminum nitride (AlN) or a material in which one selected from a group consisting of calcium, strontium, titanium, and potassium is added to the aluminum nitride. When the capacitance layer 25C includes these materials, the capacitance thereof increases. When the capacitance layer 25C includes these materials, electric conductivity of the capacitance layer 25C can be improved to curb heating due to supply of electric power. As a result, it is possible to curb a large change of the temperature of the first capacitor 25 in use.

The capacitance layer 25C may include one selected from a group consisting of lead titanate (PbTiO₃), strontium titanate (SrTiO₃), lead zirconate (PbZrO₃), tin hafnate (PbHfO₃), and relaxor ferroelectrics. When the capacitance layer 25C includes these materials, a dielectric constant of the capacitance layer 25C becomes greater and the capacitance of the first capacitor 25 becomes greater.

The first electrode 25D and the second electrode 25E are, for example, ferromagnetic layers. The same material as the first conductive layer 25A and the second conductive layer 25B can be used for the first electrode 25D and the second electrode 25E. The third electrode 25F is in contact with the second conductive layer 25B. The third electrode 25F is a conductor.

The capacitance of the first capacitor 25 changes by applying a potential difference between the first electrode 25D and the second electrode 25E and applying a writing current (a writing pulse) to the first conductive layer 25A. The capacitance of the first capacitor 25 changes in an analog manner by applying an electrical signal in one direction on the plane of the first conductive layer 25A.

The writing current (the writing pulse) moves in the magnetic domain wall DW in the first conductive layer 25A. The position of the magnetic domain wall DW changes according to the magnitude of the writing current (the writing pulse).

The capacitance of the first capacitor 25 increases as the area in which the magnetization M_{25B} of the second conductive layer 25B and the magnetization of the first conductive layer 25A are anti-parallel to each other increases and decreases as the area in which the magnetization M_{25B} of the second conductive layer 25B and the magnetization of the first conductive layer 25A are parallel to each other increases. The capacitance of the first capacitor 25 increases as the first magnetic domain A1 is widened, and the capacitance of the first capacitor 25 decreases as the second magnetic domain A2 is widened. For example, the capacitance of the first capacitor 25 changes between 1 μF and 1 pF.

When the capacitance of the first capacitor 25 is variable, it is possible to change the short term memory property according to a task given to the reservoir device 100. For example, when estimation accuracy is higher when considering older data of time-series data, it is possible to enhance the short term memory property by increasing the capacitance of the first capacitor 25. The second capacitor 26 can also employ the same configuration as the first capacitor 25.

The configuration of the sample and hold circuit 20 is not limited to the configuration illustrated in FIG. 5.

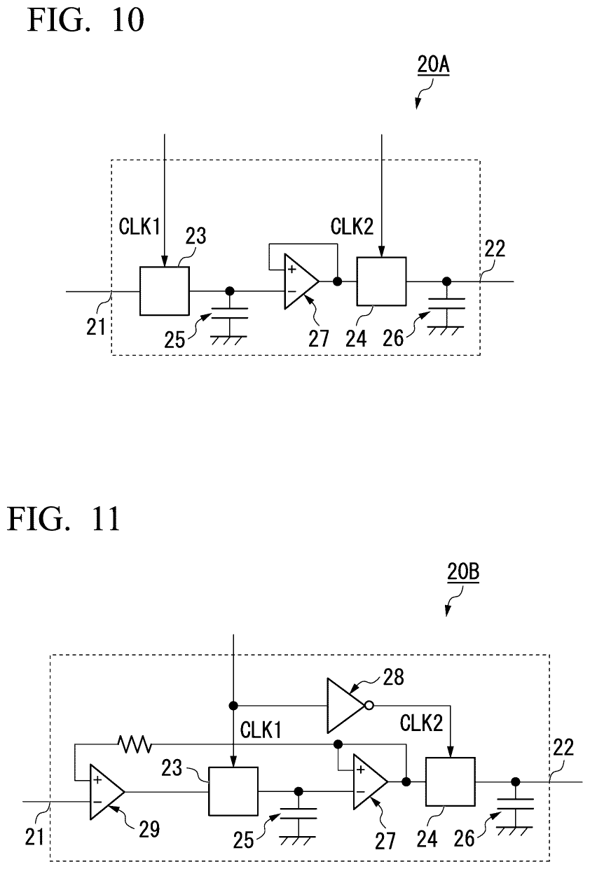

FIG. 10 is a circuit diagram of a sample and hold circuit 20A of a reservoir device according to a second modified example. The sample and hold circuit 20A is different from the sample and hold circuit 20 illustrated in FIG. 5 in that the inverter 28 is not provided.

In the sample and hold circuit 20A, the first clock signal CLK1 for controlling turning-on/off of the first switch 23 and the second clock signal CLK2 for controlling turning-on/off of the second switch 24 are separately input. The first clock signal CLK1 and the second clock signal CLK2 are independently variable.

When the second clock signal CLK2 and the first clock signal CLK1 are separately controlled, the duty ratios of the first clock signal CLK1 and the second clock signal CLK2, the frequencies of the first clock signal CLK1 and the second clock signal CLK2, and the like are variable. A holding time during which a joined signal Sₘ of an input signal Sᵢₙ and a propagated signal Pᵢₙ is held in the sample and hold circuit 20A changes according to the turning-on and turning-off timings of the first switch 23 and the second switch 24. By adjusting the holding time, the timings at which the signal is held, and the like, it is possible to adjust the short term memory property of the reservoir device.

FIG. 11 is a circuit diagram of a sample and hold circuit 20B of a reservoir device according to a third modified example. The sample and hold circuit 20B is different from the sample and hold circuit 20 illustrated in FIG. 5 in that an amplifier 29 is provided between the first terminal 21 and the first switch 23.

The sample and hold circuit 20B amplifies a joined signal input from the first terminal 21 using the amplifier 29. It is possible to perform signal analysis with higher accuracy by the sample and hold circuit 20B which amplify the joined signal . . .

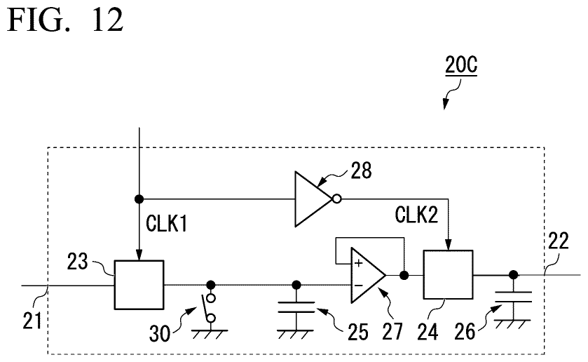

FIG. 12 is a circuit diagram of a sample and hold circuit 20C of a reservoir device according to a fourth modified example. The sample and hold circuit 20C is different from the sample and hold circuit 20 illustrated in FIG. 5 in that a switch 30 is provided between the first switch 23 and the first capacitor 25. The switch 30 can employ a known switch, and an example thereof is a MOSFET switch. When the switch 30 is turned on, electric charge accumulated in the first capacitor 25 is fully discharged. The sample and hold circuit 20C can control an amount of electric charge remaining in the first capacitor 25 by turning on or off the switch 30.

The characteristic configurations according to the first to fourth modified examples may be combined. For example, the first capacitor 25 according to the second to fourth modified examples may employ a variable capacitor. For example, the amplifier 29 or the switch 30 may be provided in the sample and hold circuit 20A according to the first modified example. For example, the switch 30 may be provided in the sample and hold circuit 20B according to the second modified example.

### Second Embodiment

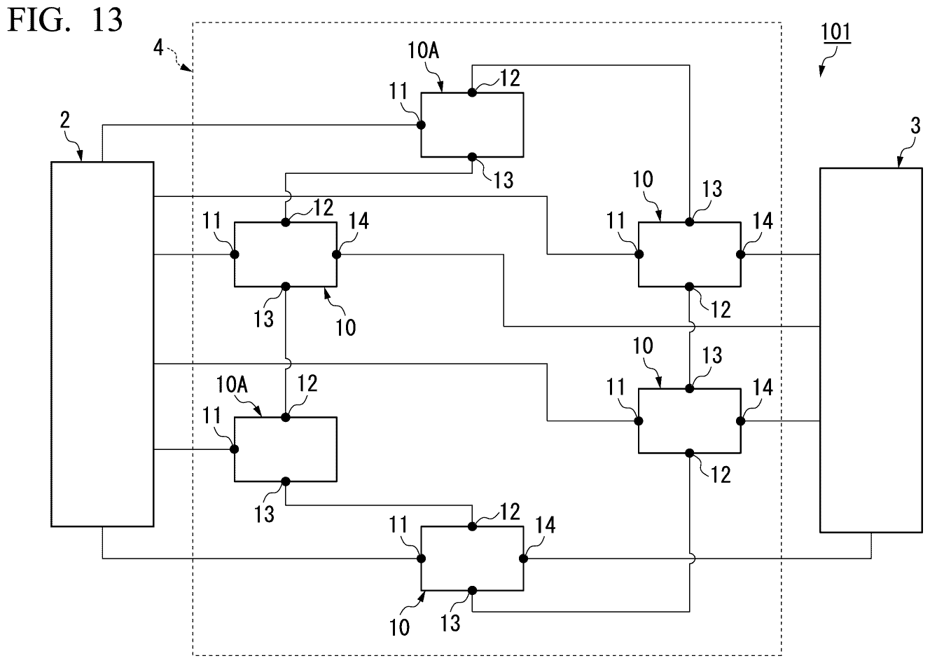

FIG. 13 is a diagram illustrating a configuration of a reservoir device 101 according to a second embodiment. The reservoir device 101 includes a reservoir 4, an input unit 2, and a read-out 3. The reservoir 4 is different from the reservoir 1 according to the first embodiment in that some of a plurality of nodes are nodes 10A. In the second embodiment, the same elements as in the first embodiment will be referred to by the same reference signs.

The reservoir 4 includes a plurality of nodes 10 and at least one node 10A. What node out of the nodes constituting the reservoir 4 is configured as the node 10A is not particularly limited. The number of nodes 10A may be one or two or more.

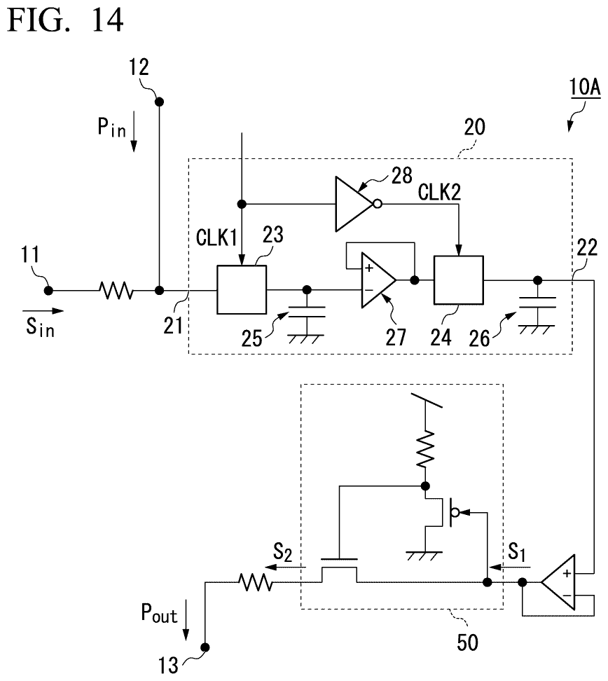

FIG. 14 is a circuit diagram of the node 10A according to the second embodiment. The node 10A includes, for example, a first input terminal 11, a second input terminal 12, a first output terminal 13, a sample and hold circuit 20, and a nonlinear circuit 50. The node 10A is different from the node 10 in that the second output terminal 14 and the output circuit 40 are not provided. The node 10A is the same as the node 10 in a state in which the third switch 41 of the output circuit 40 is turned off. The node 10A functions as an interaction of signals between the node 10 or the node 10A connected to the second input terminal 12 and the node 10 or the node 10A connected to the first output terminal 13.

The reservoir device 101 according to the second embodiment realizes a neural network using a physical circuit similarly to the reservoir device 100 according to the first embodiment and has excellent short term memory property. Each node 10 and each node 10A include the sample and hold circuit 20, and thus the short term memory property is excellent. The reservoir device 101 according to the second embodiment can employ the same modified examples as in the first embodiment.

### Third Embodiment

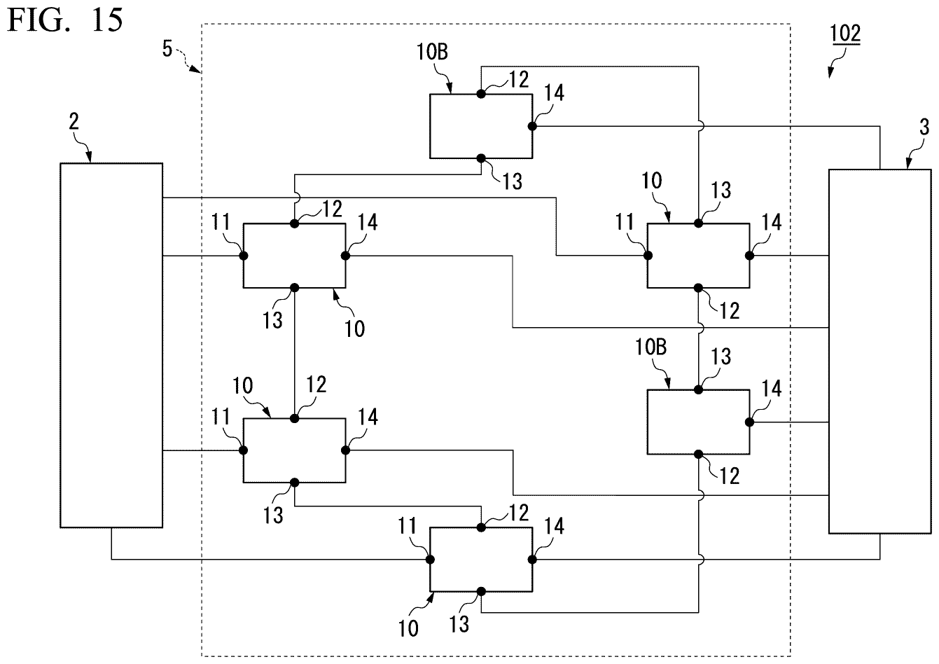

FIG. 15 is a diagram illustrating a configuration of a reservoir device 102 according to a third embodiment. The reservoir device 102 includes a reservoir 5, an input unit 2, and a read-out 3. The reservoir 5 is different from the reservoir 1 according to the first embodiment in that some of a plurality of nodes are nodes 10B. In the third embodiment, the same elements as in the first embodiment will be referred to by the same reference signs.

The reservoir 5 includes a plurality of nodes 10 and at least one node 10B. What node out of the nodes constituting the reservoir 5 is configured as the node 10B is not particularly limited. The number of nodes 10B may be one or two or more.

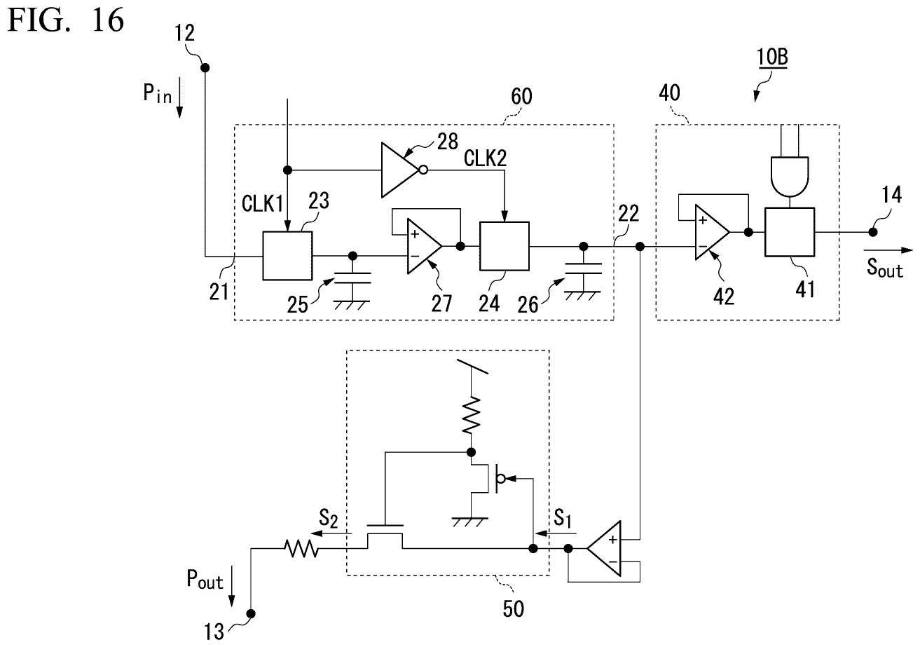

FIG. 16 is a circuit diagram of the node 10B according to the third embodiment. The node 10B includes, for example, a second input terminal 12, a first output terminal 13, a second output terminal 14, an output circuit 40, a sample and hold circuit 60, and a nonlinear circuit 50. The node 10B is different from the node 10 in that the first input terminal 11 is not provided. The second input terminal 12 in FIG. 16 is an example of a third input terminal in the claims, the first output terminal 13 in FIG. 16 is an example of a third output terminal in the claims, and the sample and hold circuit 60 is an example of a second sample and hold circuit in the claims.

The sample and hold circuit 60 has the same configuration as the sample and hold circuit 20. The sample and hold circuit 60 includes a first terminal 21, a second terminal 22, a first switch 23, a second switch 24, a first capacitor 25, a second capacitor 26, an amplifier 27, and an inverter 28. The sample and hold circuit 60 can employ the same modified examples as in the sample and hold circuit 20. The first terminal 21 of the sample and hold circuit 60 is connected to the second input terminal 12. A propagated signal Pᵢₙ is input to the first terminal 21.

The sample and hold circuit 60 holds and converts a propagated signal Pᵢₙ. When the first switch 23 is turned on and the second switch 24 is turned off, the propagated signal Pᵢₙ is held in the first capacitor 25 for a predetermined time. Subsequently, when the first switch 23 is turned off and the second switch 24 is turned on, electric charge accumulated in the first capacitor 25 is discharged. At this time, the propagated signal Pᵢₙ is nonlinearly converted. The converted signal is amplified by the amplifier 27 and is output from the second terminal 22.

The reservoir device 102 according to the third embodiment realizes a neural network using a physical circuit similarly to the reservoir device 100 according to the first embodiment. Each node 10 and each node 10B include the sample and hold circuit 20 or the sample and hold circuit 60, and thus the short term memory property is excellent. The reservoir device 102 according to the third embodiment can employ the same modified examples as in the first embodiment.

### Fourth Embodiment

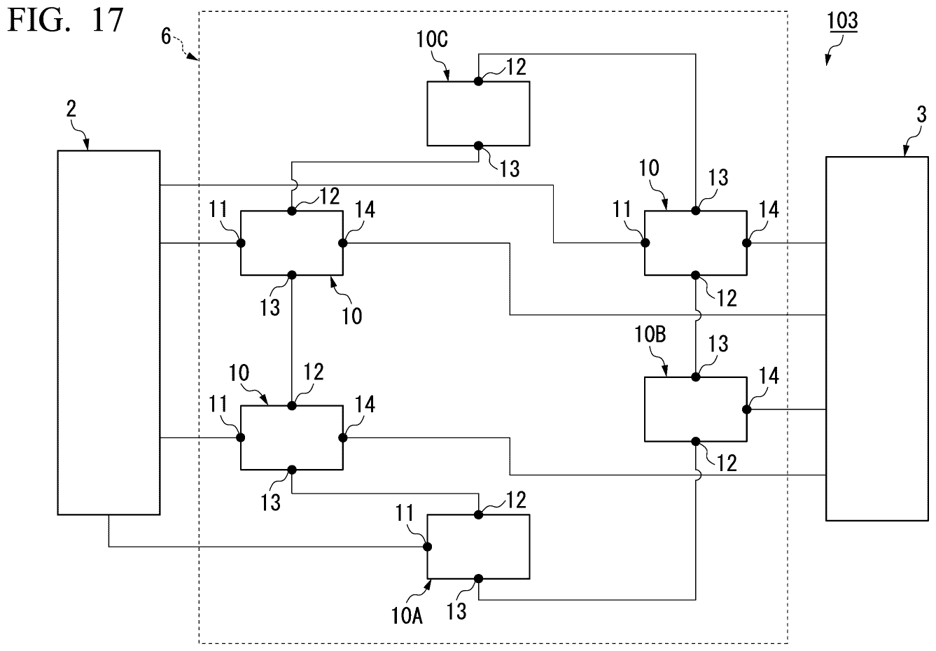

FIG. 17 is a diagram illustrating a configuration of a reservoir device 103 according to a fourth embodiment. The reservoir device 103 includes a reservoir 6, an input unit 2, and a read-out 3. The reservoir 6 is different from the reservoir 1 according to the first embodiment in that some of a plurality of nodes are a node 10A, a node 10B, and a node 10C. In the fourth embodiment, the same elements as in the first embodiment will be referred to by the same reference signs.

The reservoir 6 includes a plurality of nodes 10, at least one node 10A, at least one node 10B, and at least one node 10C. What node out of the nodes constituting the reservoir 6 is configured as the node 10A, the node 10B, or the node 10C is not particularly limited. The number of nodes 10A, the number of nodes 10B, and the number of nodes 10C may be one or two or more.

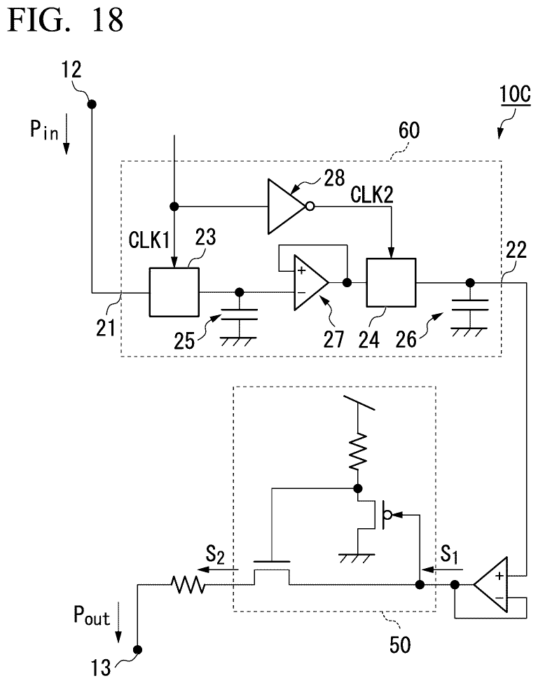

FIG. 18 is a circuit diagram of the node 10C according to the fourth embodiment. The node 10C includes, for example, a second input terminal 12, a first output terminal 13, a sample and hold circuit 60, and a nonlinear circuit 50. The node 10C is different from the node 10 in that the first input terminal 11, the second output terminal 14, and the output circuit 40 are not provided. The sample and hold circuit 60 is the same as that in the third embodiment. The node 10C functions as an interaction of signals between one of the node 10, the node 10A, the node 10B, and the node 10C connected to the second input terminal 12 and one of the node 10, the node 10B, and the node 10C connected to the first output terminal 13.

The reservoir device 103 according to the fourth embodiment realizes a neural network using a physical circuit similarly to the reservoir device 100 according to the first embodiment. Each node 10, each node 10A, each node 10B, and each node 10C include the sample and hold circuit 20 or the sample and hold circuit 60, and thus the short term memory property is excellent. The reservoir device 103 according to the fourth embodiment can employ the same modified examples as in the first embodiment.

### Fifth Embodiment

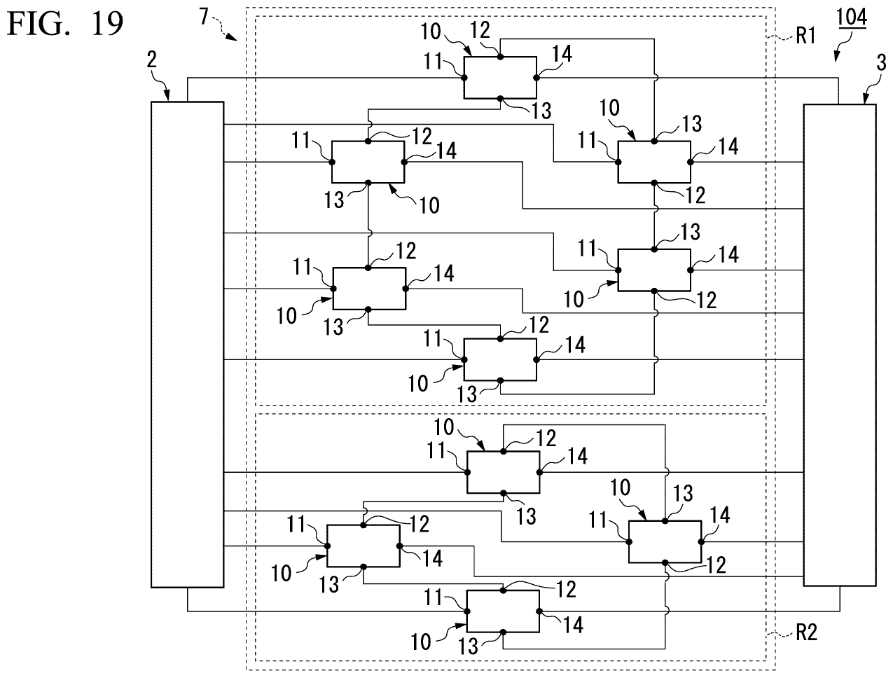

FIG. 19 is a diagram illustrating a configuration of a reservoir device 104 according to a fifth embodiment. The reservoir device 104 includes a reservoir 7, an input unit 2, and a read-out 3. The reservoir 7 is different from the reservoir 1 according to the first embodiment in that a plurality of nodes 10 form a plurality of rings. In the fifth embodiment, the same elements as in the first embodiment will be referred to by the same reference signs.

The reservoir 7 includes a first ring unit R1 and a second ring unit R2. In the first ring unit R1, a plurality of nodes 10 are connected in a ring shape by a line connecting the second input terminal 12 and the first output terminal 13. Similarly, in the second ring unit R2, a plurality of nodes 10 are connected in a ring shape by a line connecting the second input terminal 12 and the first output terminal 13. The numbers of nodes 10 constituting the first ring unit R1 and the second ring unit R2 are not particularly limited.

An input signal input to the nodes 10 in the first ring unit R1 and an input signal input to the nodes 10 in the second ring unit R2 may be the same or different from each other. For example, when there are two types of input signals, a first input signal may be input as an input signal Sᵢₙ to the nodes 10 in the first ring unit R1 and a second input signal may be input as an input signal Sᵢₙ to the nodes 10 in the second ring unit R2, or the first input signal and the second input signal may be input as input signals Sᵢₙ to the nodes 10 in each of the first ring unit R1 and the second ring unit R2.

The configuration of each node 10 in the first ring unit R1 and the configuration of each node 10 in the second ring unit R2 may be the same or different from each other. The configuration of a node 10 includes, for example, a capacitance of a capacitor, a first clock signal CLK1 input to the first switch 23, and a second clock signal CLK2 input to the second switch 24. By changing the configurations of the nodes 10 in the first ring unit R1 from the second ring unit R2, it is possible to extract features of different dimension from the same input signal.

The reservoir device 104 according to the fifth embodiment realizes a neural network using a physical circuit similarly to the reservoir device 100 according to the first embodiment and has excellent short term memory property. Since the reservoir device 104 according to the fifth embodiment includes a plurality of units in the reservoir 7, it is possible to extract various features.

In the reservoir device 104 according to the fifth embodiment, some of the nodes 10 may be replaced with one of the node 10A, the node 10B, and the node 10C. The reservoir device 104 according to the fifth embodiment can employ the same modified examples as in the first embodiment.

### Sixth Embodiment

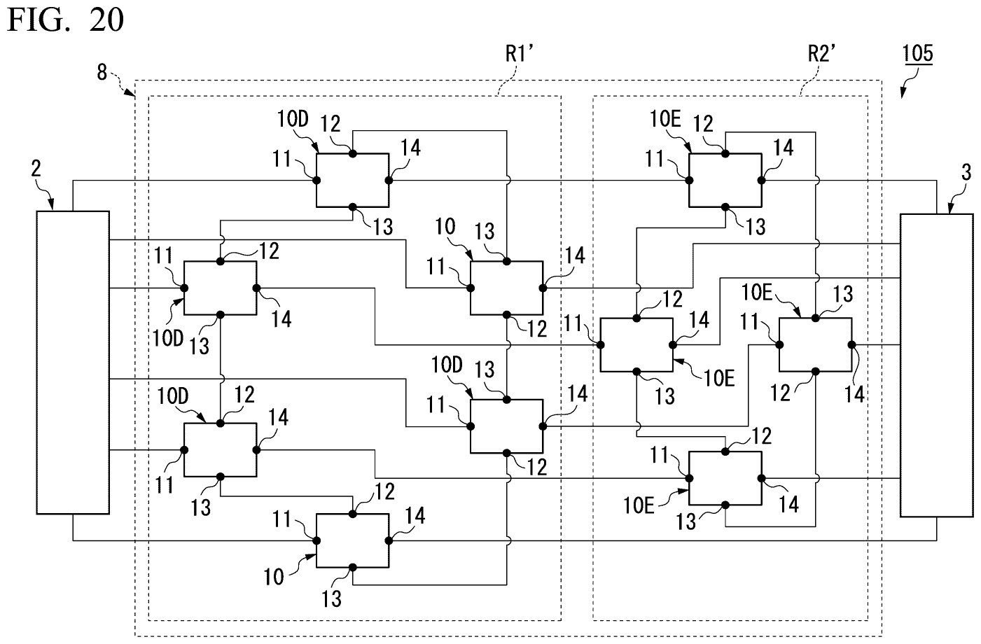

FIG. 20 is a diagram illustrating a configuration of a reservoir device 105 according to a sixth embodiment. The reservoir device 105 includes a reservoir 8, an input unit 2, and a read-out 3. The reservoir 8 is different from the reservoir 1 according to the first embodiment in that a plurality of nodes 10 form a plurality of rings. In the sixth embodiment, the same elements as in the first embodiment will be referred to by the same reference signs.

The reservoir 8 includes a first ring unit R1′ and a second ring unit R2′. In the first ring unit R1′, a plurality of nodes 10 or a plurality of nodes 10D are connected in a ring shape by a line connecting the second input terminal 12 and the first output terminal 13. Similarly, in the second ring unit R2′, a plurality of nodes 10 or a plurality of nodes 10E are connected in a ring shape by a line connecting the second input terminal 12 and the first output terminal 13. The numbers of nodes 10, nodes 10D, and nodes 10E constituting the first ring unit R1′ and the second ring unit R2′ are not particularly limited.

The node 10D has the same configuration as the node 10. The node 10D is different from the node 10 in that the second output terminal 14 is configured to be connectable to the first input terminal 11 of another node 10E.

The node 10E has the same configuration as the node 10. The node 10E is different from the node 10 in that the first input terminal 11 is configured to be connectable to the second output terminal 14 of another node 10D.

The first ring unit R1′ and the second ring unit R2′ are formed in a hierarchical shape, the first ring unit R1′ operates a first-half process of the reservoir 8, and the second ring unit R2′ operates a second-half process of the reservoir 8.

The configuration of each node 10 or each node 10D in the first ring unit R1′ and the configuration of each node 10 or each node 10E in the second ring unit R2 may be the same or different from each other. By changing the configurations of the nodes in the first ring unit R1′ from the second ring unit R2′, it is possible to enhance an expressive ability of the reservoir 8 and to perform more complex processes. The reservoir 8 can form a feature space with a high expressive ability corresponding to a task.

The reservoir device 105 according to the sixth embodiment realizes a neural network using a physical circuit similarly to the reservoir device 100 according to the first embodiment. Since the reservoir device 105 according to the sixth embodiment includes a plurality of units in the reservoir 8, it is possible to further enhance the expressive ability of the reservoir 8.

In the reservoir device 105 according to the sixth embodiment, some of the nodes 10, the nodes 10D, or the nodes 10E may be replaced with one of the node 10A, the node 10B, and the node 10C. The reservoir device 105 according to the sixth embodiment may include a plurality of ring units in parallel similarly to the fifth embodiment. The reservoir device 105 according to the sixth embodiment can employ the same modified examples as in the first embodiment.

### Seventh Embodiment

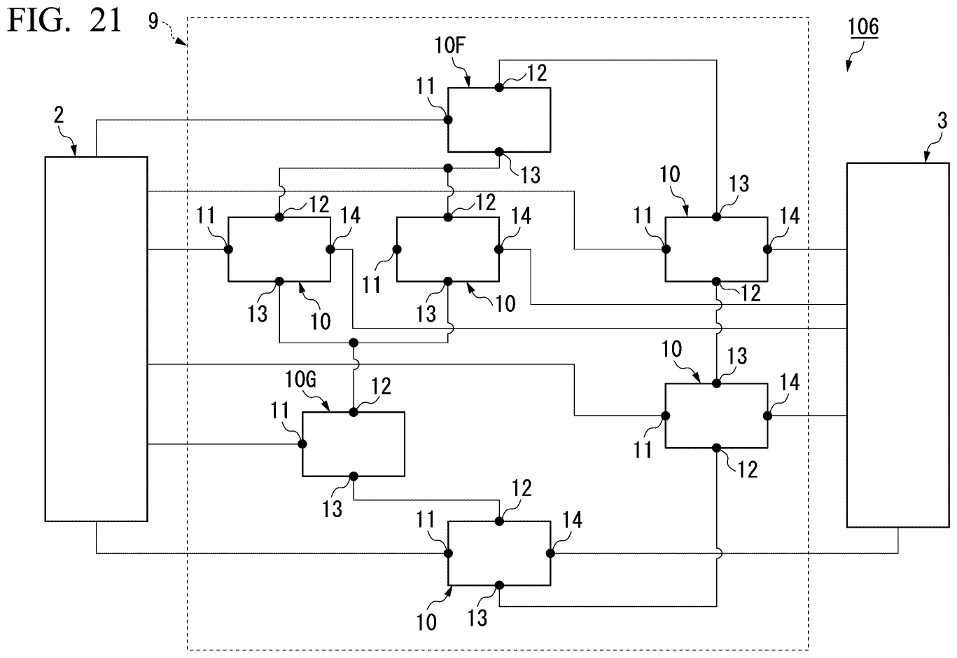

FIG. 21 is a diagram illustrating a configuration of a reservoir device 106 according to a seventh embodiment. The reservoir device 106 includes a reservoir 9, an input unit 2, and a read-out 3. The reservoir 9 is different from the reservoir 1 according to the first embodiment in that some nodes 10 of a plurality of nodes 10 are connected to a plurality of nodes 10. In the seventh embodiment, the same elements as in the first embodiment will be referred to by the same reference signs.

The reservoir 9 includes a plurality of nodes 10, at least one node 10F, and at least one node 10G. The first output terminal 13 of the node 10F is configured to be connectable to the plurality of nodes 10. The second input terminal 12 of the nodes 10G is configured to be connectable to the plurality of nodes 10. The configurations of the node 10F and the node 10G are the same as the node 10.

The reservoir device 106 according to the seventh embodiment realizes a neural network using a physical circuit similarly to the reservoir device 100 according to the first embodiment and has excellent short term memory property. In the reservoir device 106 according to the seventh embodiment, since connections between the nodes 10, the node 10F, and the node 10G in the reservoir 9 become more complicated, it is possible to further enhance the expressive ability of the reservoir 9.

In the reservoir device 106 according to the seventh embodiment, some of the nodes 10 may be replaced with one of the node 10A, the node 10B, and the node 10C. The reservoir device 106 according to the seventh embodiment can employ the same modified examples as in the first embodiment. The reservoir device 106 according to the seventh embodiment may include a plurality of ring units in the reservoir 9.

### EXPLANATION OF REFERENCES

1, 4, 5, 6, 7, 8, 9 Reservoir
2 Input unit
3 Read-out
10, 10A, 10B, 10C, 10D, 10E, 10F, 10G Node
11 First input terminal
12 Second input terminal
13 First output terminal
14 Second output terminal
20, 20A, 20B, 20C, 60 Sample and hold circuit
21 First terminal
22 Second terminal
23 First switch
24 Second switch
25 First capacitor
25A First conductive layer
25B Second conductive layer
25C Capacitance layer
25D First electrode
25E Second electrode
25F Third electrode
25G Insulating layer
26 Second capacitor
27, 29 Amplifier
28 Inverter
30 Switch
40 Output circuit
100, 101, 102, 103, 104, 105, 106 Reservoir device
200 Information processing device
201 Physical reservoir
202 Processor
203 Memory
204 Communication device
205 Bus
CLK1 First clock signal
CLK2 Second clock signal
Pᵢₙ, Pₒᵤₜ Propagation signal
Sᵢₙ Input signal
Sₒᵤₜ Output signal
S₁ First signal
S₂ Second signal cm What is claimed is:

1. A node comprising a first input terminal, a second input terminal, a first sample and hold circuit, and a first output terminal,
wherein the first input terminal is configured to be connectable to an input source for transmitting an input signal to a reservoir device,
wherein the second input terminal is configured to be connectable to at least one other node,
wherein a first terminal of the first sample and hold circuit is connected to the first input terminal and the second input terminal,
wherein a second terminal of the first sample and hold circuit is connected to the first output terminal,
wherein the first output terminal is configured to be connectable to at least one other node, and
wherein the first sample and hold circuit holds and converts a joined signal of the input signal and a propagated signal from the second input terminal.

2. The node according to claim 1, wherein the first sample and hold circuit includes a first switch, a second switch, a first capacitor, a second capacitor, and an amplification circuit,
wherein the first switch is disposed between the first terminal and the first capacitor,
wherein the first capacitor is disposed between the first switch and the second switch,
wherein the second switch is disposed between the first capacitor and the second capacitor,
wherein the second capacitor is disposed between the second switch and the second terminal, and
wherein the amplification circuit is connected to the first capacitor and amplifies a potential of the first capacitor.

3. The node according to claim 2, wherein the first capacitor is a variable capacitor of which a capacitance is variable.

4. The node according to claim 2, wherein the second switch is turned off when the first switch is turned on, and
wherein the first switch is turned off when the second switch is turned on.

5. The node according to claim 2, wherein a first clock signal for controlling turning-on/off of the first switch or a second clock signal for controlling turning-on/off of the second switch is variable.

6. The node according to claim 1, further comprising a second output terminal connected to the second terminal,
wherein the second output terminal is configured to be connectable to a read-out for outputting a signal to outside of the reservoir device.

7. The node according to claim 6, further comprising a third switch that is disposed between the second output terminal and the second terminal.

8. The node according to claim 1, further comprising a nonlinear circuit,
wherein the nonlinear circuit is connected to the second terminal and the first output terminal.

9. The node according to claim 8, wherein the nonlinear circuit nonlinearly converts a first signal input to the nonlinear circuit to a second signal,
wherein the second signal and the first signal satisfy a relational expression of y≠ax+b, and
wherein y in the relational expression is the second signal, x is the first signal, and a and b are arbitrary values.

10. The node according to claim 1, wherein the second input terminal is configured to be connectable to a plurality of nodes.

11. The node according to claim 1, wherein the first output terminal is configured to be connectable to a plurality of nodes.

12. A reservoir device comprising a plurality of nodes,
wherein at least one of the plurality of nodes is the node according to claim 1.

13. The reservoir device according to claim 12, wherein at least some of the plurality of nodes are connected in a ring shape.

14. The reservoir device according to claim 12, wherein the at least one of the plurality of nodes includes a third input terminal, a second sample and hold circuit, and a third output terminal,
wherein the third input terminal is configured to be connectable to at least one other node,
wherein a first terminal of the second sample and hold circuit is connected to the third input terminal,
wherein a second terminal of the second sample and hold circuit is connected to the third output terminal,
wherein the third output terminal is configured to be connectable to at least one other node, and
wherein the second sample and hold circuit holds and converts a propagated signal from the third input terminal.
